(19) United States
(12) Patent Application Publication
(10) Pub. No.: US 2026/0225457 A1
(43) Pub. Date: Aug. 6, 2026

(54) SYSTEM AND METHOD FOR COORDINATING AND CONTROLLING DRIVING AND/OR BRAKING TORQUES, AND MOTOR VEHICLE

(71) Applicant: Robert Bosch GmbH, Stuttgart (DE)

(72) Inventors: Abel Eckart, Leingarten (DE); Andreas Haun, Grosswallstadt (DE); Carsten Bodmann, Ludwigsburg (DE); Christoph Diekmann, Besigheim (DE); Jens Berg, Bad Rappenau (DE); Markus Beisswenger, Schwaebisch Hall (DE); Philipp Woerz, Talheim (DE)

(21) Appl. No.: 19/148,432

(22) PCT Filed: Feb. 2, 2024
(86) PCT No.: PCT/EP2024/052622

§ 371 Date: Jul. 16, 2025

(30) Foreign Application Priority Data
Feb. 20, 2023 (DE) 10 2023 201 427.0

(51) Int. Cl. B60L 3/10

(52) U.S. Cl. CPC B60L 3/108; B60L 2220/42; B60L 2240/423; B60L 2240/463; B60L 2240/465; B60L 2260/28

(57) ABSTRACT

A system and a method for coordinating and controlling driving and braking torques in a vehicle. A request for the driving and braking torques is processed in a hierarchical structure, wherein multiple functional levels are provided in the hierarchical structure. The functional levels include a level for the entire vehicle, a level for the individual axles of the vehicle, a level for the individual wheels on the axles of the vehicle, and a further level for the corresponding actuators for realizing the driving and operating torques.

### FIELD

The present invention relates to a system and a method for coordinating and controlling driving and/or braking torques in a vehicle. The present invention also relates to a motor vehicle comprising such a system for coordinating and controlling driving and/or braking torques.

### BACKGROUND INFORMATION

Vehicles that are fully or at least partially electrically driven are becoming increasingly important. Such vehicles have an electric drive system that can drive the vehicle by means of electrical energy from a traction battery. In addition, this electric drive system can also be operated in a generator mode. In this case, the kinetic energy of the vehicle is converted into electrical energy by means of an electric machine. This electrical energy can be used to charge the traction battery of the vehicle.

In common braking strategies for electric vehicles, the braking torque generated by the electric motor is limited. For example, Germany Patent Application No. DE 10 2012 217 679 A1 describes that a braking torque generated by an electric machine and applied to a rear axle of the vehicle is limited in such a way that the slip present at the wheels of the rear axle does not exceed a predetermined limit value.

### SUMMARY

The present invention provides a system and a method for coordinating and controlling driving torques and/or braking torques in a vehicle as well as a motor vehicle comprising such a system. Advantageous example embodiments of the present invention are disclosed herein.

According to an example embodiment of the present invention, the following is provided:

A system for coordinating and controlling driving torques and/or braking torques in a vehicle, comprising a first processing module, multiple second processing modules, multiple third processing modules, and multiple fourth processing modules. The first processing module is designed to receive a request for a driving or braking torque of the vehicle. This request may in particular be a request for an accelerating or decelerating total wheel torque. Furthermore, the first processing module is designed to process the received request for the driving or braking torque of the vehicle according to specifications for the entire vehicle. Furthermore, the first processing module is designed to divide the processed request for the driving or braking torque of the vehicle between multiple axles of the vehicle. The second processing modules are each designed to receive a request for a driving or braking torque for an axle from the first processing module. Furthermore, the second processing modules are each designed to process the received request for the driving or braking torque according to specifications of the corresponding axle and to divide the processed request between the wheels of the corresponding axle. The third processing modules are each designed to receive a request for a driving or braking torque for a wheel from the second processing modules and to process the received request according to specifications for the corresponding wheel. The fourth processing modules are each designed to receive the processed requests for a driving or braking torque for a wheel from the third processing modules and to process them according to specifications for an actuator to be controlled, and to provide, according to the processing, a corresponding control signal to the actuator to be controlled.

Furthermore, according to an example embodiment of the present invention, the following is provided:

A motor vehicle comprising an electric drive system, a brake device and a system according to the present invention for coordinating and controlling driving and/or braking torques. The electric drive system is designed to drive and/or decelerate wheels of the motor vehicle. The brake device is designed to brake wheels of the motor vehicle.

Additionally, according to an example embodiment of the present invention, the following is provided:

A method for coordinating and controlling driving torques and/or braking torques in a vehicle. The method comprises a step of receiving a request for a driving or braking torque of the vehicle. This request may in particular be a request for an accelerating or decelerating total wheel torque. Furthermore, the method comprises a step of processing the received request for the driving or braking torque of the vehicle according to specifications for the entire vehicle, and a step of dividing the processed request for the driving or braking torque between multiple axles of the vehicle. The method further comprises a step of processing the request for the driving or braking torque divided between the multiple axles of the vehicle, wherein the processing is carried out in each case according to specifications of the corresponding axles of the vehicle. Furthermore, the method comprises a step of dividing the processed request for the driving or braking torque between multiple wheels of the corresponding axle of the vehicle. The method further comprises a step of processing the request for the driving or braking torque divided between the multiple wheels of the axles of the vehicle, wherein the processing is carried out according to specifications for the corresponding wheels of the vehicle. Furthermore, the method comprises a step of processing the request for the driving or braking torque processed according to the specifications for the corresponding wheels, in each case according to further specifications of an actuator to be controlled. Finally, the method comprises a step of providing control signals to the actuators, wherein the control signals are provided according to the requests for the driving or braking torque previously processed according to the specifications of the actuators.

The present invention is based on the finding that numerous boundary conditions must be taken into account for stabilizing the driving behavior of a motor vehicle during propulsion and deceleration. The boundary conditions to be taken into account may relate to various functional hierarchy levels. Some boundary conditions may, for example, be evaluated with respect to the entire vehicle, such as the complete chassis of the vehicle. In addition, the boundary conditions may also be evaluated individually for the individual axles of the vehicle or individually for each wheel of an axle. In addition, some boundary conditions may further also be considered for the individual actuators for accelerating or decelerating the vehicle. The present invention is based in particular on the finding that the analysis, evaluation and, if necessary, an intervention in an adjustment of the control parameters for stabilizing the driving behavior during propulsion and deceleration of the vehicle can represent a very complex task.

It is therefore an idea of the present invention to account for this finding and to create a concept for coordinating and controlling driving and/or braking torques, which can decouple different levels, such as the aforementioned levels of the entire vehicle, axles, wheels, and actuators, from one another and thus allows specific processing or evaluation for each level. According to an example embodiment of the present invention, the individual hierarchy levels can be communicatively coupled to one another, for example according to standardized interfaces. It is thus possible to create a structured and standardized system that easily decouples the different functional levels from one another. This makes simple, structured processing possible for each individual functional level. In particular, each functional level can be individually adjusted according to the corresponding requests. In this way, it is, for example, also possible to use existing structures when designing and developing new systems and to adjust only the changed functional components or levels accordingly.

According to an example embodiment of the present invention, the division of the different functional or hierarchical levels can be realized by individual, separate components. In principle, however, it is also possible to realize the individual processing modules as software modules of a common control mechanism, for example with a microprocessor and a corresponding program code. In particular, due to the standardization of interfaces between the individual processing modules, it is possible to distribute the functional levels/processing modules to different control units.

Generic functions for mutual coordination or arbitration of different requests to the particular processing modules are described in the individual processing modules. Since standardized interfaces are provided between the individual modules, decoupling of the functional control technology and the actuator technology can be achieved by the separate processing modules.

In addition, the processing modules can also provide chaining of the individual hierarchical levels. This always results in a mathematically determined structure. Conflicting requests are thus resolved mathematically and transformed toward safe states.

Although the concept according to the present invention is particularly well suited for fully or at least partially electrically driven vehicles comprising at least one electric drive component, the basic principle is equally applicable to vehicles comprising any other suitable drive type.

According to one example embodiment of the present invention, the processing modules, i.e., the first processing module, the second processing modules, the third processing modules, and the fourth processing modules, are each communicatively coupled to one another by means of predetermined (hardware) interfaces. If the individual processing modules are separate units, the data exchange can be carried out via corresponding standardized communication protocols and (software) interfaces. If the individual processing modules are implemented as software modules of a common microprocessor unit, the data exchange between the individual processing modules can also be carried out in this case via specified defined interfaces between the individual software modules. This makes it possible to replace the individual processing modules easily or to adapt them to the particular circumstances of the vehicle.

According to one example embodiment of the present invention, the system further comprises a monitoring device. The monitoring device is designed to ascertain a characteristic variable for a behavior between a road surface and the wheels of the vehicle. Such a characteristic variable may, for example, comprise a friction coefficient between the road surface and the tires on the wheels of the vehicle. In addition, however, other characteristic variables are also possible, which may, for example, be obtained directly or indirectly from information from an assistance system such as ABS or the like. For example, the friction coefficient may be ascertained from the slip of a wheel. This slip may, for example, be determined using a current actual speed of the vehicle and the rotational speed of the wheel by using the diameter or circumference of the wheel. Of course, any other suitable approaches for ascertaining the friction coefficient are also possible. If the friction coefficient is known, the processing modules, in particular the first processing module, the second processing modules, the third processing modules, and the fourth processing modules, can be designed to carry out the processing of the requests for the driving and braking torques by using the ascertained friction coefficient. For example, a maximum driving torque or maximum deceleration torque may be limited according to the ascertained friction coefficient. This can prevent the vehicle from swerving and can thus improve the stability of the driving behavior. Furthermore, the driving behavior can be influenced specifically by adjusting the driving and braking torque. Since the communication between the individual components involves standardized interfaces to the actuator layer, there is also a decoupling of the functional control technology and the actuator technology.

According to one example embodiment of the present invention, the fourth processing modules are each designed to control the corresponding actuator by using a predetermined maximum slip of a wheel. This means that, for example, when accelerating and/or braking the vehicle, the corresponding actuator, i.e., the electric drive system or the brake actuator, can be controlled in such a way that a maximum specified slip is not exceeded on the corresponding wheel.

According to one example embodiment of the present invention, the processing modules, in particular the first processing module, the second processing modules, and the third processing modules are designed to process the requests for the driving and braking torques by using a vehicle velocity, a longitudinal acceleration, and/or a lateral acceleration. In addition, any other parameters that influence the stability of the driving behavior may of course also be included in the processing. For example, further parameters from information of the steering system, such as steering angle or the like, aerodynamic components, etc., may be used. The corresponding data for vehicle velocity, longitudinal acceleration, and lateral acceleration may be ascertained either by sensors or calculated or estimated in a suitable manner. Accordingly, the requested driving or braking torques can be adjusted during processing in such a way that the stability of the driving behavior can be ensured, taking into account the current vehicle parameters. For example, by adjusting the requested torques for driving or braking behavior accordingly, the braking torques can either be limited or the division of the requested torques between the axles or wheels can be adjusted in such a way that specifications for longitudinal acceleration and lateral acceleration are not exceeded.

According to one example embodiment of the present invention, processing the request for the driving and braking torques comprises limiting the requested driving or braking torques to a previously ascertained maximum value. As already explained, by limiting the driving and braking torques, the stability of the driving behavior can be increased, especially when accelerating and braking the vehicle. The limitation of the driving and braking torques can be carried out at different functional levels, for example for the entire vehicle chassis, the individual axles, and the individual wheels.

According to one example embodiment of the present invention, the processing modules, in particular the first processing module, the second processing modules, the third processing modules, and/or the fourth processing modules are designed to receive specifications for the maximum driving or braking torque from a controller for electronic stabilization of the vehicle. For example, such specifications may be specified by a traction control system, an anti-lock braking system, an all-wheel drive control system, or a further vehicle agility/stabilization system.

According to one example embodiment of the present invention, the request for the driving or braking torque comprises a request from a user. Additionally or alternatively, the request for the driving or braking torque may comprise a request from a component of a driver assistance system. For example, if the request comes from a user, it can be transmitted by actuating an accelerator pedal to accelerate or a brake pedal to decelerate the vehicle. Driver assistance systems or systems for fully or at least partially autonomous driving of a vehicle can also issue requests for setting a driving or braking torque. For example, such requests can be issued by a speed assistance system, a brake assist or the like.

The above example embodiments and developments can be combined with one another in any manner insofar as is reasonable. Further embodiments, developments, and implementations of the present invention also include combinations, even those not explicitly mentioned, of features of the present invention described above or in the following with regard to the exemplary embodiments. A person skilled in the art will in particular also add individual aspects as improvements or additions to the respective basic forms of the present invention, in view of the disclosure herein.

### BRIEF DESCRIPTION OF THE DRAWINGS

Further features and advantages of the present invention will be explained in the following with reference to the figures.

FIG. 1 is a block diagram of a vehicle comprising a system for coordinating and controlling driving and/or braking torques according to one example embodiment of the present invention.

FIG. 2 is a schematic diagram for illustrating a system for coordinating and controlling driving and/or braking torques according to one example embodiment of the present invention.

FIG. 3 is a block diagram for illustrating the basic principle as underlying the concept for coordinating and controlling driving and/or braking torques according to one example embodiment of the present invention.

FIG. 4 is a flowchart as may be the basis of a method for coordinating and controlling driving and/or braking torques according to one example embodiment of the present invention.

### DETAILED DESCRIPTION OF EXAMPLE EMBODIMENTS

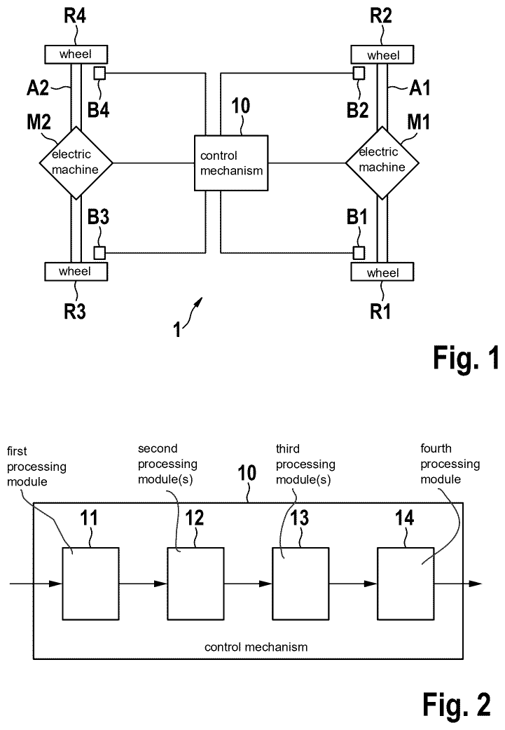

FIG. 1 is a schematic representation of a block diagram of a vehicle 1, as may be the basis of a vehicle comprising a system for coordinating and controlling driving and braking torques according to one embodiment. The vehicle 1 may in particular be a fully or at least partially electrically driven vehicle. Such electric vehicles comprise an electric drive system, in which electrical energy, for example from a traction battery, is provided to an electric machine by means of a power converter in order to drive the electric machine. Alternatively, the electric machine may also be operated in a generator mode, wherein kinetic energy of the vehicle is converted into electrical energy by means of the electric machine. The output voltage provided by the electric machine can be converted by means of the power converter into an electrical voltage suitable for recharging the electrical energy store of the vehicle. This process is also known as regeneration.

Although the following exemplary embodiment is explained with reference to a vehicle comprising an electric drive system, vehicles comprising other suitable drive technologies are also possible in principle. The reference to electric drive systems does not represent a limitation of the present invention.

For example, a separate electric machine M1, M2 may be provided for each axle A1, A2 of the vehicle 1. Alternatively, it is also possible to provide an electric machine M1, M2 for only one of the two axles A1 or A2. Furthermore, any other implementations are possible. For example, a separate drive system may also be provided for each wheel for one or both axles A1, A2.

Two wheels R1 to R4 may be provided on each axle A1, A2 of the vehicle 1. The distribution of the driving and, as the case may be, also braking torques from the electric machine M1, M2 to the individual wheels may be controlled in any way. However, the details of techniques used here are not the subject matter of this invention and the techniques are therefore not discussed in more detail.

Furthermore, a brake actuator B1 to B4 may be provided for each wheel R1 to R4, for example. This may, for example, be a hydraulically or electromechanically actuated brake actuator B1 to B4. In principle, however, any other suitable braking systems are also possible.

For controlling the brake actuators B1 to B4 and the components of the electric drive systems M1, M2, a control mechanism 10 may be provided, which generates and provides the control signals for the particular actuators. This request may in particular be a request for an accelerating or decelerating total wheel torque. For example, a request for a driving torque or a braking torque may be transmitted to this control mechanism 10. It is understood that the control mechanism 10 may also be realized by multiple individual mechanisms. The control mechanism 10 can then process this request and, taking into account current vehicle parameters and specifications, control the required actuators. In particular, the control mechanism 10 can distribute the request for a driving torque or a braking torque between the individual actuators and/or limit it so that specified boundary conditions are not exceeded and/or specifications regarding vehicle stability can be met.

As explained in more detail below, when a braking torque is requested, the requested braking torque may, for example, be divided between the brake actuators B1 to B4 of the individual wheels R1 to R4. Likewise, a requested driving torque may be divided between the individual axles A1, A2 or the individual wheels R1 to R4. By dividing the driving and braking torques specifically, it can be ensured that specified boundary conditions are not exceeded and that the stability of the vehicle can be ensured.

The processing of the requested driving and braking torques, in particular any required limitation and division of the torques between the individual axles A1, A2 and wheels R1 to R4, is carried out in a hierarchical structure according to the functional architecture of the driving and braking system. This is described in more detail below.

FIG. 2 is a schematic representation of a block diagram for explaining the functional principle of a system 10 for coordinating and controlling the driving and braking torques in a vehicle 1. The system 10 for coordinating and controlling the driving and braking torques may comprise a first processing module 11, which processes the requested driving and braking torques on a functional level for the entire vehicle and divides them according to the next, lower functional level. This subsequent functional level may, for example, be the functional level of the individual axles A1, A2 in the case of the described vehicle 1. Accordingly, for processing a requested driving or braking torque, the first processing module 11 can first check whether a maximum permissible value has been exceeded or a minimum permissible value has not been met. For example, if a driving torque is requested that cannot be realized according to the current vehicle parameters because, for example, the electrical energy store cannot provide the required power or the maximum power has to be limited for thermal reasons, a limitation can already be carried out at this global vehicle level. Analogously, appropriate limitations can also be carried out for a requested braking torque if necessary.

The first processing module 11 can then divide the requested driving or braking torque between the individual axles A1, A2 of the vehicle 1. Any suitable approaches for dividing the requested torques may be used. For example, a user or another system component of the vehicle can select a specific driving or operating mode for the vehicle 1, wherein such a selected mode can also be linked to a corresponding division of the torques. For example, depending on the user's driving preferences or the road conditions, a choice can be made between a front-wheel drive, rear-wheel drive, or all-wheel drive. It is also possible to set different torque distributions according to user specifications, such as sport mode, eco mode, or the like.

If necessary, the torque distribution may also be divided within specified ranges between the individual axles A1, A2 in order to optimize wear on the tires or the brake components. In addition, current vehicle parameters such as actual speed, longitudinal acceleration, or lateral acceleration or the like can also be taken into account. Of course, any other parameters for dividing the driving and braking torques between the individual axles A1 and A2 are also possible.

The resulting requests for driving or braking torques of the individual axles A1, A2 can then be output to one or more second processing modules 12. These second processing modules 12 can process the requested driving and braking torques at the axle level and may, if necessary, carry out limitations or the like of the requested torques for each axle A1, A2. For example, if a driving torque for an axle is requested that cannot currently be realized by the electric drive system because, for example, a power limitation or the like is active, the corresponding second processing module 12 can limit the requested driving torque accordingly. Furthermore, further boundary conditions, such as a limitation of the driving torque in an eco mode, adjustment of the transmission behavior in a sport mode or the like, can also be taken into account. In addition, an ascertained friction coefficient between tires and road surface may also be taken into account, for example.

In addition, the second processing modules 12 can appropriately divide the driving or braking torques requested for the particular axles A1, A2 between the corresponding wheels R1 to R4 of the corresponding axles A1, A2. The resulting desired driving or braking torques for the individual wheels R1 to R4 can then be passed to one or more third processing modules 13.

The third processing modules 13 can then process the requested driving or braking torques individually for each wheel and limit them if necessary. Here, too, vehicle parameters, such as actual velocity, longitudinal acceleration, or lateral acceleration, or any other suitable vehicle parameters or settings in the driving or operating mode of the vehicle may, for example, be taken into account in limiting the maximum torques on the individual wheels R1 to R4. Furthermore, ascertained information on a friction coefficient between the tires on the wheels R1 to R4 and the road surface may, for example, also be taken into account here. The resulting requests for the driving or braking torques at the individual wheels R1 to R4 can subsequently be passed to one or more fourth processing modules 14.

The fourth processing modules 14 can receive the request for the driving or braking torques of the individual wheels R1 to R4 and then control the required actuators, such as the drive systems M1, M2 or the brake actuators B1 to B4. For this purpose, the fourth processing modules 14 can process the received requests for the driving or braking torques beforehand and, if necessary, further adjust them. For example, the requests for the driving or braking torques can be adjusted by the fourth processing modules 14 in order not to exceed a maximum specified slip between wheels R1 to R4 and road surface. Of course, other specifications may also be taken into account here.

By means of such a hierarchical approach, in which a request for a driving or braking torque is processed in multiple functional levels and divided step by step, a structure that allows efficient processing of the requested torques can be easily achieved. The requested torque for maintaining vehicle stability can be processed individually at each functional level. The modular, hierarchical structure of the individual functional levels makes it possible to carry out an adjustment easily at each functional level. The individual functional levels or the processing modules 11 to 14 of the respective functional levels can be communicatively coupled to one another via standardized interfaces. Such communicative coupling can be realized with separate hardware modules as well as with software modules.

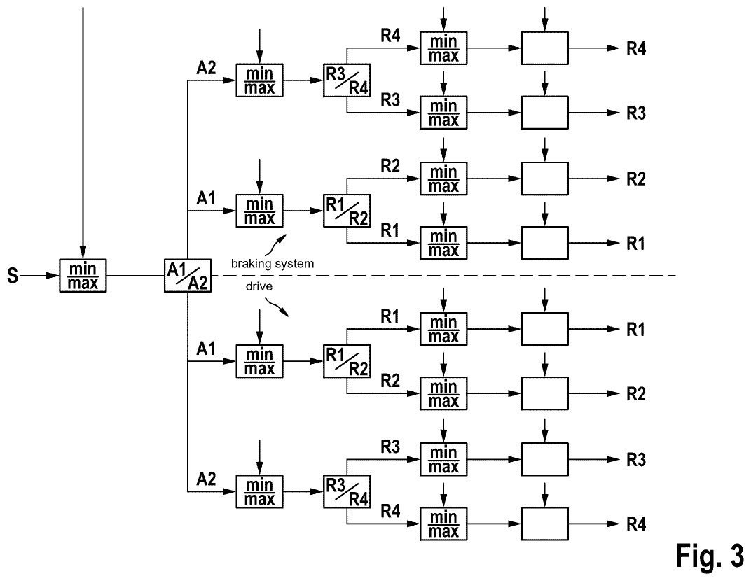

FIG. 3 is a schematic representation for realizing a system for coordinating and controlling driving and braking torques, as may be the basis of an embodiment. Functions for controlling the braking torques are shown in the upper area above the dashed line, and the functions for requesting driving torques are shown in the lower area.

As shown on the left in FIG. 3, a request S for a driving or braking torque can first be provided to the system 10. This request S is first processed at the level of the entire vehicle. For example, the received request S may be limited to a maximum value. The request S may originate from a user or driver of the vehicle and from the component of a driver assistance system for fully or at least partially autonomous driving of the vehicle. For example, a brake assist may issue a request to decelerate the vehicle, a speed assist may issue a request to accelerate or brake the vehicle, or any other component may issue a corresponding request.

After the request has been processed at the level of the entire vehicle and, if necessary, has been limited to a maximum value, this processed value can be divided between the individual axles A1, A2 of the vehicle. Any suitable parameters and specifications can be taken into account. For example, the driving torque may be divided between the individual axles according to a selected driving mode. Furthermore, information on friction coefficients between the tires and the road surface on the individual axles can also be taken into account. In addition, vehicle parameters, such as current velocity, longitudinal acceleration, or lateral acceleration or the like, may, for example, also be taken into account in order to optimize the driving stability of the vehicle when dividing the torques between the individual axles.

After the requested driving or braking torque has been divided between the individual axles A1 and A2, the requested torque can then be processed individually for each of the axles A1, A2. Here, too, the maximum driving or braking torques may be limited if necessary, for example taking into account previously ascertained friction coefficients between tires and road surface. In addition, any other parameters for processing and limiting the requested torques are of course also possible.

The resulting requested torque for each axle can subsequently be divided between the two wheels of the corresponding axle A1, A2. Here, too, any parameters, such as vehicle velocity, longitudinal acceleration, or lateral acceleration, friction coefficient between tires and road surface or the like, can be taken into account.

Furthermore, for each resulting requested driving or braking torque at one of the wheels R1 to R4, the requested torques can subsequently be processed, in particular limited to a maximum value. Here, too, boundary conditions such as longitudinal acceleration, lateral acceleration, friction coefficient, etc. may, for example, be taken into account.

Finally, the resulting requests for the driving or braking torques can each be processed for an actuator of the corresponding wheel R1 to R4. The actuators to be controlled can be controlled to achieve the requested torque. If necessary, further boundary conditions, such as a maximum permissible slip of the individual wheels R1 to R4, can also be taken into account in order to control the actuators accordingly.

As can be further seen in FIG. 3, separate units can be provided, if necessary, for limiting the requests to minimum and/or maximum values on the one hand and for distributing them to multiple hierarchically subordinate elements on the other hand. Accordingly, depending on the functionality implemented, only the interfaces required for this purpose can be provided or implemented on the corresponding units. In this way, the individual units can be realized more easily if necessary.

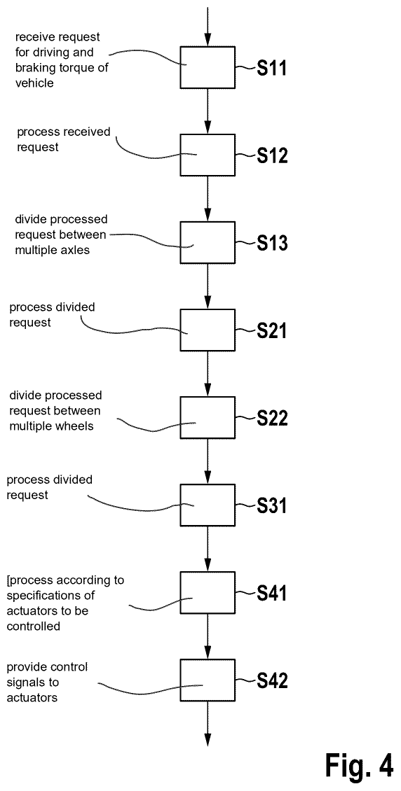

Finally, FIG. 4 is a flowchart as may be the basis of a method for coordinating and controlling driving and braking torques in a vehicle 1 according to one embodiment. The method can in principle comprise any steps as have already been described in connection with the system for coordinating and controlling driving and braking torques. Analogously, the above-described system for coordinating and controlling driving and braking torques can also comprise any components as described below in connection with the method for coordinating and controlling driving and braking torques.

In step S11, a request for a driving and braking torque of a vehicle 1 is first received. In step S12, the received request for the driving and braking torque of the vehicle is processed according to the specification for the entire vehicle 1. Subsequently, in step S13, the processed request is divided between the multiple axles A1, A2 of the vehicle 1.

In step S21, the request for the driving or braking torque divided between the multiple axles A1, A2 of the vehicle 1 is processed, wherein the processing is carried out in each case according to the specifications of the corresponding axle of the vehicle 1. Subsequently, in step S22, the processed request for the driving and braking torque is divided between multiple wheels R1 to R4 of the corresponding axles A1, A2 of the vehicle 1.

In step S31, the request for the driving or braking torque divided between the multiple wheels of the axles A1, A2 of the vehicle 1 is processed, wherein the processing is carried out in each case according to specifications of the corresponding wheels R1 to R4 of the vehicle 1.

In step S41, the requests for the driving or braking torque processed according to the specifications for the corresponding wheels R1 to R4 are processed according to the specifications of an actuator to be controlled. Finally, in step S42, control signals are provided to the actuators, wherein the control signals are provided according to the requests for the driving and braking torque processed using the specifications of the actuators.

In summary, the present invention relates to a system and a method for coordinating and controlling driving and braking torques in a vehicle, in particular a fully or at least partially electrically driven vehicle. For this purpose, it is proposed to process the request for the driving and braking torques in a hierarchical structure, wherein multiple functional levels are provided in the hierarchical structure. The functional levels comprise a level for the entire vehicle, a level for the individual axles of the vehicle, a level for the individual wheels on the axles of the vehicle, and a further level for the corresponding actuators for realizing the driving and operating torques.

1-10. (canceled)

11. A system for coordinating and controlling driving and/or braking torques in a vehicle, comprising:
a first processing module configured to receive a request for a driving or braking torque of the vehicle, to process the received request according to specifications for the vehicle, and to divide the processed request between multiple axles of the vehicle;
multiple second processing modules, each configured to receive a request for a driving or braking torque for a corresponding axle from the first processing module, to process the received request according to specifications of the corresponding axle, and to divide the processed request as accelerating or decelerating wheel torques between corresponding wheels of the corresponding axle;
multiple third processing modules, each configured to receive a request for a driving or braking torque for a corresponding wheel from one of the second processing modules and to process the received request according to specifications of the corresponding wheel of the corresponding axle;
multiple fourth processing modules, each configured to receive a processed request for a driving or braking torque for a corresponding wheel from one of the third processing modules, to process the received processed request according to specifications for an actuator to be controlled, and to provide a corresponding control signal to the actuator to be controlled.

12. The system according to claim 11, wherein the first processing module, the second processing modules, the third processing modules, and the fourth processing modules are each communicatively coupled to one another by predetermined interfaces.

13. The system according to claim 11, further comprising:
a monitoring device configured to ascertain a friction coefficient between a road surface and tires of the wheels of the vehicle;
wherein the first processing module, the second processing modules, the third processing modules, and the fourth processing modules, carry out the processing of the requests for the driving and braking torques using the ascertained friction coefficient.

14. The system according to claim 11, wherein the fourth processing modules are each configured to control the corresponding actuator by using a predetermined maximum slip of a wheel.

15. The system according to claim 11, wherein the first processing module, the second processing modules, and the third processing modules are each configured to process the requests for the driving and braking torques by using a vehicle velocity, and/or a longitudinal acceleration, and/or a lateral acceleration.

16. The system according to claim 11, wherein the processing of the request for the driving and braking torques includes limiting the requested driving or braking torque to a previously ascertained maximum value.

17. The system according to claim 11, wherein the first processing module, the second processing modules, the third processing modules, and the fourth processing modules, are configured to receive specifications for the maximum driving or braking torque from a controller for electronic stabilization of the vehicle.

18. The system according to claim 11, wherein the request for a driving or braking torque comprises a request from a user or a component of a driver assistance system.

19. A motor vehicle, comprising:
a drive system configured to drive and/or decelerate wheels of the motor vehicle;
a brake device configured to brake wheels of the motor vehicle; and
a system configured to coordinate and control driving and/or braking torques, the system including:
a first processing module configured to receive a request for a driving or braking torque of the vehicle, to process the received request according to specifications for the vehicle, and to divide the processed request between multiple axles of the vehicle,
multiple second processing modules, each configured to receive a request for a driving or braking torque for a corresponding axle from the first processing module, to process the received request according to specifications of the corresponding axle, and to divide the processed request as accelerating or decelerating wheel torques between corresponding wheels of the corresponding axle,
multiple third processing modules, each configured to receive a request for a driving or braking torque for a corresponding wheel from one of the second processing modules and to process the received request according to specifications of the corresponding wheel of the corresponding axle, and
multiple fourth processing modules, each configured to receive a processed request for a driving or braking torque for a corresponding wheel from one of the third processing modules, to process the received processed request according to specifications for an actuator to be controlled, and to provide a corresponding control signal to the actuator to be controlled.

20. A method for coordinating and controlling driving and/or braking torques in a vehicle, comprising the following steps”
receiving a request for a driving or braking torque of the vehicle;
processing the received request for the driving or braking torque of the vehicle according to specifications for the entire vehicle;
dividing the request for the driving or braking torque processed according to the specifications for the entire vehicle, between multiple corresponding axles of the vehicle;
processing the request for the driving or braking torque divided between the multiple corresponding axles of the vehicle, in each case according to specifications of the corresponding axle of the vehicle;
dividing the request for the driving or braking torque processed according to the specifications for the corresponding axles, between multiple corresponding wheels of the corresponding axle of the vehicle;
processing the request for the driving or braking torque divided between the multiple corresponding wheels of the axles of the vehicle, in each case according to specifications of the corresponding wheel of the vehicle;
processing the request for the driving or braking torque processed according to the specifications for each of the corresponding wheels, according to the specifications of an actuator to be controlled; and
providing control signals to the actuators by using the requests for the driving or braking torque processed according to the specifications of the actuators.
